(19) United States
(12) Patent Application Publication
(10) Pub. No.: US 2020/0239707 A1
(43) Pub. Date: Jul. 30, 2020

(54) FUNCTIONALISED GRAPHENE COMPOSITION

(71) Applicant: Talga Technologies Limited, Cambridge (GB)

(72) Inventors: Mallika HL BOHM, Godmanchester (GB); Sivasambu BOHM, Godmanchester (GB); Karanveer S. ANEJA, Cambridge (GB)

(73) Assignee: Talga Technologies Limited, Cambridge (GB)

(21) Appl. No.: 16/634,016

(22) PCT Filed: Jul. 25, 2018
(86) PCT No.: PCT/GB2018/052095

§ 371 Date: Jan. 24, 2020

(30) Foreign Application Priority Data
Jul. 26, 2017 (GB) 1712050.2

(51) Int. Cl. C09D 5/08; C01B 32/19; C01B 32/194; C09D 7/62; C09D 7/45; C09D 7/40; C09D 163/00; C09D 175/06

(52) U.S. Cl. CPC C09D 5/084; C01B 32/19; C01B 32/194; C09D 7/62; C01B 2204/32; C09D 7/70; C09D 163/00; C09D 175/06; C09D 7/45

(57) ABSTRACT

The present invention relates to a graphene composition for use in a coating composition that comprises a resin and a hardener, wherein the resin or the hardener is an active hydrogen-containing component and graphene in the graphene composition is functionalised with i) a dispersing agent comprising any of the following functional groups: —NH2, —OH and —O═C—NH and ii) an active hydrogen-containing compound being either a) a hardener comprising any of the following functional groups: amino, amide, hydroxyl, carboxylic acid, anhydride, isocyanate, phenol and thiol or, b) a polyol resin

### TECHNICAL FIELD OF THE INVENTION

The present invention relates to a coating composition comprising functionalised graphene and to a method for making the coating composition comprising functionalised graphene. The invention also relates to a coated substrate in which the coating comprises functionalised graphene and to a method for producing the coated substrate.

### BACKGROUND TO THE INVENTION

Polymeric resins are widely used to protect metals against corrosion. The inert nature of polymeric resins provides an effective barrier against corrosion. In order to perform to their corrosion inhibiting ability, polymeric resins are required to possess mechanical properties. In cases where polymeric resins are used for exterior applications or as a top coat, they are additionally required to possess resistance against UV degradation and in some cases they must also exhibit good resistance to abrasion.

The incorporation of graphene into polymeric resins is an area of growing interest and this is typically achieved by dispersing graphene flakes in a polymeric resin or a hardener. However, when graphene flakes are dispersed in the resin or the hardener directly, the coatings obtained are known to exhibit reduced mechanical strength and increased water and ionic permeability because the graphene flakes are not homogeneously distributed and/or appropriately aligned to form an impermeable barrier. When not distributed properly in the resin, the graphene flakes are also known to recombine into larger graphitic structures which is also understood to reduce the corrosion resistance properties of the resulting coatings.

It is also known to react graphene oxide or reduced graphene oxide flakes with the resin or hardener of the coating formulation. However, in this case the oxide defects and the reduced flake size can adversely affect the mechanical strength, electrical conductivity and barrier properties of the resulting coating.

Accordingly, it is an object of embodiments of the present invention to provide a coated substrate where the coating exhibits improved corrosion resistance and mechanical properties.

It is another object of embodiments of the present invention to provide a coated substrate where the coating exhibits reduced permeability to water and corrosive ions.

It is also an object of embodiments of the present invention to provide a composition that inhibits the recombination of graphene into larger graphitic structures.

### SUMMARY OF THE INVENTION

According to a first aspect of the invention there is provided a graphene composition for use in a coating composition that comprises a resin and a hardener, wherein the resin or the hardener is an active hydrogen-containing component and graphene in the graphene composition is functionalised with a dispersing agent and the active hydrogen-containing component.

It has been found that improvements in corrosion resistance and in the mechanical properties of a coating can be obtained by functionalising graphene with a dispersing agent and an active hydrogen-containing component of a two pack coating composition and then reacting the functionalised graphene with the resin or hardener as appropriate. In particular, it was found that coatings comprising functionalised graphene exhibited improved corrosion resistance relative to coatings where graphene flakes were incorporated without first functionalising the graphene flakes with a dispersing agent and the active hydrogen-containing component. The inventors also found that coatings which incorporated functionalised graphene exhibited improved UV resistance, abrasion resistance, adhesion, tensile strength and reduced water and ionic permeability relative to coatings where graphene was absent from the coating matrix. The obtained coatings also exhibited reduced water permeability relative to conventional organic zinc rich coatings and inorganic zinc silicate coatings.

The dispersing agent may comprise amino (—NH₂), hydroxyl (—OH) or carboamide (NHC═O) functional groups. It has been found that dispersing agents comprising amino, hydroxyl and carboamide functional groups are very suitable for reacting with the edge electrons of graphene and that improvements in corrosion resistance and in the mechanical properties of the coatings thus formed can be obtained.

The graphene composition may comprise an organic solvent such as xylene, toluene, ethyl acetate, ethanol, hexane, isopropanol and propyl acetate. Alternatively, the graphene composition may comprise water or a mixture of an organic solvent and water if appropriate.

The graphene composition may comprise a solvent based dispersing agent. The dispersing agent may comprise any of the following functional groups, either alone or in combination: amino, hydroxyl and carboamide. The solvent based dispersing agent may comprise a high molecular weight copolymer. In particular, the dispersing agent may be an alkylammonium salt of a high molecular-weight copolymer such as BYK9076. The dispersing agent could also be a high molecular-weight copolymer having pigment affnic groups such as BYK9077.

The graphene composition may comprise a water based dispersing agent. The dispersing agent may comprise any of the following functional groups, either alone or in combination: amino, hydroxyl and carboamide. The water based dispersing agent may comprise a high molecular-weight copolymer having pigment affnic groups. Examples of water based dispersing agents that may be used in accordance with the present invention include: DisperBYK2010, DisperBYK2012, Anti terra 250, DisperBYK 190, BYK093, BYK022, and BYK1640.

The active hydrogen-containing component may be a hardener comprising any of the following functional groups: aromatic amides, cycloaliphatic amides, aliphatic amides, aromatic amines, cycloaliphatic amines, aliphatic amines, phenols, anhydrides and thiols. The hardener may be a polymeric hardener. These functional groups are very suitable for reacting with an epoxy resin of a two-pack coating composition. In particular, the epoxy resin may comprise any of the following, either alone or in combination: bisphenol A diglycidyl ether (DGEBA), bisphenol F epoxy resin, novolac epoxy resin, aliphatic epoxy resin and glycidylamine epoxy resin. Examples of Commercial brands that may be used in accordance with the present invention include: Loctite®, Epikote®, Epibond®, Epocast®, Epikotetm®, Epo-tek®, Araldite®, Epotec®, Cetepox®.

The active hydrogen-containing component may be a resin such as a polyol resin. In particular, the polyol resin may comprise any of the following, either alone or in combination: acrylic polyols, polyester based polyols and polyether based polyols such as polyethylene glycol, polypropylene glycol and poly(tetramethylene ether) glycol.

If a polyurethane coating is desired then the polyol resin may be reacted with an isocyanate hardener. The hardener may for instance comprise aliphatic isocyanates, aromatic isocyanates or a combination of aliphatic and aromatic isocyanates as desired or as appropriate. Examples of aromatic isocyanates that may be used in accordance with the present invention include: diisocyanates such as Toluene Diisocyanate (TDI) and Methylene diphenyl diisocyanate (MDI), whereas suitable aliphatic isocyanates include 1,6-hexamethylene diisocyanate (HDI), 1-isocyanato-3-isocyanatomethyl-3,5,5-trimethyl-cyclohexane (isophorone diisocyanate, IPDI), 4,4′-diisocyanato dicyclohexylmethane, (H12MDI and hydrogenated MDI).

Alternatively, if a polyester coating is desired, then the polyol resin may be reacted with a hardener comprising acidic functional groups. In particular, the hardener may comprise a dicarboxylic acid and the dicarboxylic acid may comprise any of the following, either alone or in combination: Oxalic Acid, Malonic acid, Succinic acid, Glutaric acid, Adipic acid, Pimelic acid, Suberic acid, Azelaic acid. Sebacic acid, Brassylic acid and Thapsic acid.

The graphene may be pristine graphene that is free from oxides. It should be understood that this does not include graphene that has been reduced from graphene oxide since it is known that some graphene oxide remains after the reduction step. When oxide-free graphene is used, the dispersing agent and the active hydrogen-containing component react with free electrons located at the graphene edges to form functionalised graphene. By using oxide-free graphene rather than graphene oxide (GO) or reduced graphene oxide (RGO), improvements in corrosion resistance and in the mechanical properties of the coatings thus formed can be obtained.

The composition may comprise graphene flakes. The graphene flakes may be in the form of graphene nano platelets (GNP) and/or few layer graphene (FLG). The graphene flakes may have a surface area of 1 to 10 microns. In particular, the surface area of the graphene flakes may be between 3 and 10 microns.

The composition may comprise an intercalating agent. The intercalating agent may comprise quaternary ammonium ions. In particular, the intercalating agent may be a quaternary ammonium salt such as tetrabutyl ammonium sulphate. The provision of the intercalating agent helps to ensure that GNP and FLG do not recombine to form larger graphitic structures which may be important if coatings with reduced layer thicknesses are desired.

The composition may comprise corrosion inhibitive pigments. For instance, the corrosion inhibitive pigments may comprise one or more cations selected from zinc, magnesium, titanium, zirconium, yttrium, lanthanum and cerium. These inhibitors are particularly suitable for reacting with hydroxyl ions that are generated as a by-product of a zinc corrosion process that occurs when a galvanised steel substrate is cut or scratched. The corrosion inhibitive pigments may comprise salts of zinc, magnesium, titanium, zirconium, yttrium, lanthanum and cerium. The salts may comprise acetate, nitrate or sulphate anions.

According to a second aspect of the invention there is provided a method of preparing the graphene composition according to the first aspect of the invention, wherein the method comprises the steps of functionalising graphene with a dispersing agent to form pre-functionalised graphene and then reacting pre-functionalised graphene with an active hydrogen-containing component.

The method according to the second aspect of the invention can be used to prepare the composition of the first aspect of the invention. Accordingly, the method according to the second aspect of the invention may incorporate any or all features described in relation to the first aspect of the invention as appropriate.

It is understood that the step of pre-functionalising graphene with the dispersing agent helps prevent against the agglomeration of GNP and FLG and facilitates the subsequent functionalisation of graphene with the active-hydrogen containing component. Moreover, by functionalising graphene with the dispersing agent first, this ensures that good dispersion of graphene in the active-hydrogen containing component is obtained.

In an embodiment of the invention oxide-free graphene may be functionalised with the dispersing agent and the active-hydrogen containing component.

Oxide-free graphene may be obtained by mining graphite ore from a graphite ore body; subjecting the graphite ore to an electrolytic treatment to obtain an oxide-free expanded graphitic material, and subjecting the oxide-free expanded graphitic material to an exfoliation treatment to obtain single-layer graphene, few-layer graphene and graphene nanoplatelets. The electrolytic treatment may be carried out in the presence of a non-oxidising electrolyte. For instance, the non-oxidising electrolyte may comprise ammonium sulphate.

According to a third aspect of the invention there is provided a coating composition, wherein the coating composition comprises:
a) a resin;
b) a hardener for the resin;
c) a dispersing agent, and
d) functionalised graphene, wherein the resin or the hardener is an active hydrogen-containing component and the graphene is functionalised with the dispersing agent and the active hydrogen-containing component.

The coating composition according to the third aspect of the invention may comprise the graphene composition according to the first aspect of the invention and therefore the coating composition of the third aspect of the invention may, as appropriate, incorporate any or all features described in relation to the first aspect of the invention.

The coating composition may comprise at least 0.1 wt % graphene. For instance, in one embodiment the coating composition may comprise 0.1-20 wt % graphene. In some embodiments the composition may comprise 0.1-10 wt % graphene. In particular, the composition may comprise 0.1-5 wt % graphene.

The dispersing agent may comprise 0.1-5.0 wt % of the dispersing agent. In some embodiments the composition may comprise 0.1-3.0 wt % of the dispersing, while in other embodiments the content of the dispersing agent in the coating composition may be 0.1-1.0 wt %.

The coating composition may comprise an epoxy resin and a hardener as the active hydrogen-containing component. The hardener may comprise any of the following functional groups: amino, amide, hydroxyl, carboxylic acid, anhydride, phenol and thiol. The epoxy resin: hardener ratio may be between 1:1 and 5:1. In some embodiments, the resin: hardener ratio may be 1:1, 1.5:1, 2:1, 2.5:1, 3:1, 3.5:1, 4:1, 4.5:1 or 5:1, depending on the number of functional groups in resin and hardener.

In another embodiment of the invention the active hydrogen-containing component may be a polyol resin and the hardener may comprise an isocyanate or a carboxylic acid to form polyurethane and polyester coatings respectively. When the coating composition comprises a polyol resin and a hardener, the resin: hardener ratio may be between 1:1 and 5:1. In some embodiments, the resin: hardener ratio may be 1:1, 1.5:1, 2:1, 2.5:1, 3:1, 3.5:1, 4:1, 4.5:1 or 5:1, depending on the number of functional groups in resin and hardener.

According to a fourth aspect of the invention there is provided a coated substrate comprising a substrate and a coating layer, wherein the coating layer is formed from the coating composition according to the third aspect of the aspect of the invention.

The coating layer of the coated substrate according to the fourth aspect of the invention is formed from the coating composition according to the third aspect of the invention and may therefore incorporate any or all features described in relation to the third aspect of the invention as appropriate.

It has been found that coating layers formed from the coating composition comprising functionalised graphene form a strong three-dimensional network that improves the corrosion resistance and the mechanical properties of the coating.

In one embodiment the coated substrate may be a pre-finished steel substrate. The pre-finished steel substrate may comprise a substrate, a metallic layer on the steel substrate, a pre-treatment layer on the metallic layer, a primer layer on the pre-treatment layer and an outer layer on the primer layer.

The coating layer may have a dry film thickness of between 15 μm and 300 μm when for instance the coating layer is an outer layer. In some embodiments the thickness of the outer layer may be between 25 μm and 200 μm. In other embodiments the thickness of the outer layer may be between 100 μm and 200 μm.

The coating layer may be used as a primer layer in a pre-finished steel product. When the coating layer is a primer layer the dry film thickness of the coating layer may be between 1 μm and 25 μm. In some embodiments the dry film thickness of the coating layer may be between 5 and 20 μm. In other embodiments, the dry film thickness of the coating layer may be between 5 and 15 μm. In particular, the coating layer may have a dry film thickness of between 5 and 10 μm.

The substrate may be made from a metal or a metal alloy substrate such as steel. The substrate may be provided with a metallic coating. The metallic coating may be a metal coating or a metal alloy coating. The metallic coating may comprise any of the following metals, either alone or in combination: zinc, aluminium and magnesium. In particular, the substrate may be a galvanised steel or a Galvalume® steel. Alternatively, the substrate may be a polymeric substrate.

According to a fifth aspect of the invention there is provided a method of producing a coated substrate, wherein the method comprises the step of applying the coating composition according to the third aspect of the invention to at least a part of the substrate.

The method according to the fifth aspect of the invention can be used to prepare the coated substrate of the fourth aspect of the invention. Accordingly, the method according to the fifth aspect of the invention may incorporate any or all features described in relation to the third aspect of the invention and the fourth aspect of the invention as appropriate.

Following application of the coating composition onto the substrate, the coated substrate may be heated to a temperature of at least 50° C. to cure and harden the resin. In particular, the coated substrate may be cured at a temperature of between 50° C. and 230° C. More particularly, the coated substrate may be cured at a temperature between 100° C. and 200° C.

### DETAILED DESCRIPTION OF THE INVENTION

In order that the invention may be more clearly understood one or more embodiments thereof will now be described, by way of example only, with reference to the accompanying drawings, of which:

FIG. 1 shows a schematic of coated substrates without graphene, with graphene and with functionalised graphene.

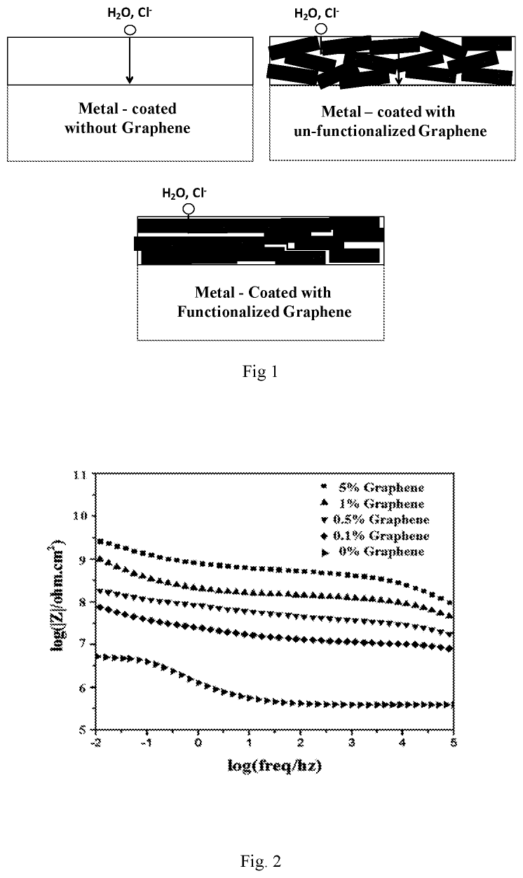

FIG. 2 shows the results of an Electrochemical Impedance Spectroscopy experiment for epoxy coatings comprising varying amounts of functionalised graphene.

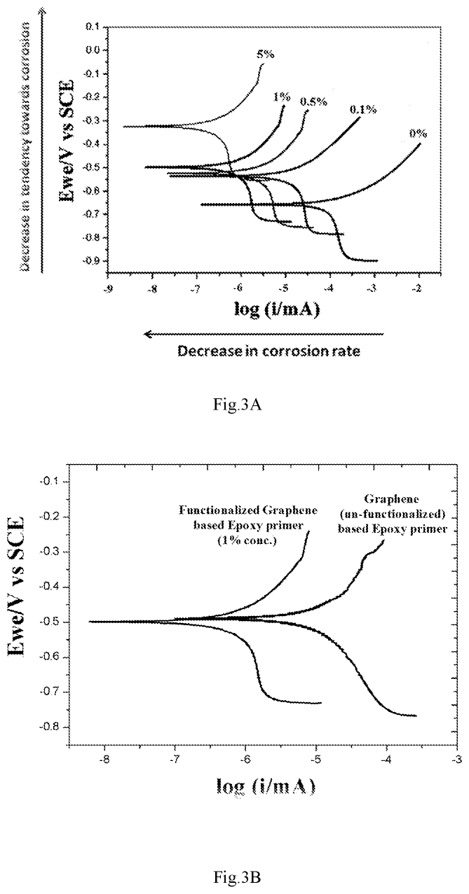

FIG. 3A shows the results of Potentiodynamic Polarization (LP) experiments for epoxy coatings comprising varying amounts of functionalised graphene.

FIG. 3B shows the results of Potentiodynamic Polarization (LP) experiments for epoxy coatings comprising functionalised graphene and non-functionalised graphene.

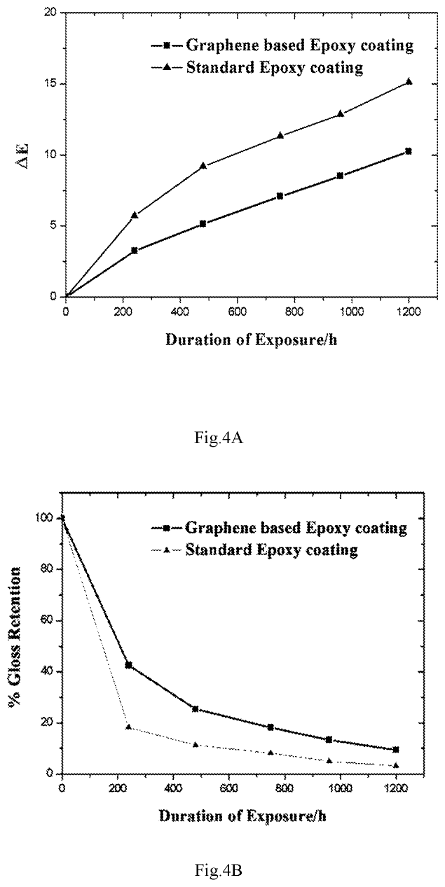

FIGS. 4A and 4B show the results of a weathering test carried out on epoxy coatings with and without functionalised graphene.

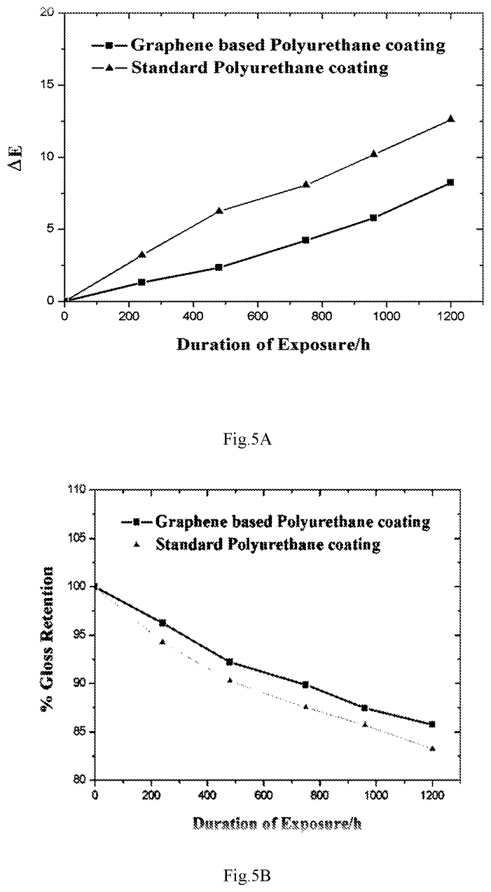

FIGS. 5A and 5B show the results of a weathering test carried out on polyurethane coatings with and without functionalised graphene.

### EXAMPLE 1: GRAPHENE PREPARATION

A suitable graphite material “Vittangi graphite”, being a strong, conductive graphite bearing ore, was identified and is available to the Applicant in the Nunasvaara deposit in Sweden, being a predominantly microcrystalline flake Joint Ore Reserves Committee (JORC 2012) mineral resource of 9.8 Mt at 25.3%-46.7% graphite (Cg). Grades for this deposit have been drill tested at an average of 35% Cg, with grades attaining up to 46.7% Cg. The rock strength has been measured at approximately 120 MPa and the resistivity at less than 10 Ohm-meter, for example 0.0567 Ohm-meter. A graphite deposit of the nature of the Nunasvaara deposit in Sweden would not be, and has not been to date, considered an appropriate source of graphitic material feedstock for the production of graphene. Graphite bearing ore obtained from the Nybrannan deposit as part of the Jalkunen Project is also a suitable material that is available to the Applicant for the production of graphene.

The graphite ore is extracted by known quarry mining methods with abrasive disks, saws or wires and other known non-explosive methods of rock extraction in an ore extraction step. The blocks of ore obtained have sizes which are suitable for transport, transfer movement, and handing. The blocks may be further cut into smaller shapes or forms of electrodes which are considered more suitable for presentation to an electrolytic process. The blocks may be cubic, cylindrical, trapezoidal, conical, or rectangular in shape and have a preferred minimum dimension of 50 mm and maximum dimension of 2000 mm. More particularly, the blocks have a minimum dimension of 100 mm and maximum dimension of 1000 mm, or still more particularly a minimum dimension of 150 mm and maximum dimension of 500 mm.

The ore blocks from the graphitic deposit are employed directly as electrodes in electrolysis for the production of nano-micro platelet graphite. In this embodiment the extracted graphite ore is used as the anode, copper metal is used as the cathode and the electrolytic treatment is carried out in the presence of a 1M ammonium sulphate solution having a pH of 6.5-7.5. The voltage applied to exfoliate the extracted graphite into nano-micro platelet graphite was 10V and the ammonium sulphate solution was concurrently stirred at 1000 rpm.

The nano-micro platelet graphite obtained after the electrolytic treatment has substantially unaltered properties relative to the graphite ore from which it is produced. Moreover, the obtained nano-micro platelet graphite exhibited increased interlayer spacing between adjacent graphitic sheets relative to the observed interlayer spacing of nano-micro platelet graphite obtained from synthetic graphite or highly ordered pyrolytic graphite (HOPG).

Following the electrolytic treatment and before further exfoliation of the micro-nano platelet graphite into graphene, sulphate anions were separated from the solution containing the micro-nano platelet graphite. This was achieved by subjecting the solution containing the micro-nano platelet graphite to a liquid-liquid separation treatment in which the solution was added to kerosene. Since sulphate anions are more soluble in kerosene than in water they readily migrate and are solubilised into the organic solvent, which facilitates their removal from the solution containing the micro-nano platelet graphite. The micro-nano platelet graphite obtained following this beneficiation treatment comprises 80-99% by weight of carbon.

The micro-nano platelet graphite obtained from the beneficiation treatment was then subjected to a combined chemical and high pressure exfoliation treatment. The chemical treatment involves mixing the micro-nano platelet graphite (100 g) with an aqueous ammonium tetrabutyl ammonium sulphate solution (0.5 wt %) to intercalate ammonium ions between the graphitic layers of the micro-nano platelet graphite. It will be appreciated that an ammonium persulphate solution (0.5 wt %) could be used instead of the ammonium sulphate solution. The aqueous ammonium sulphate solution additionally comprises Antiterra 250 (1 wt %) and/or DISPERBYK 2012 (2 wt %) both of which are manufactured by BYK. This solution is then kept at room temperature and pressure for a period of 7 days to increase the content of intercalated ammonium ions between the graphitic layers.

The solution containing the intercalated micro-nano platelet graphite and surfactants is then subjected to a high pressure treatment in an M-110Y high pressure pneumatic homogenizer which involves the use of a high pressure jet channel in an interaction mixing chamber. The solution containing intercalated micro-nano platelet graphite and surfactants is pumped from opposite sides of the homogeniser into the mixing chamber. This causes two highly accelerated liquid dispersion streams to collide with pressurised gas (1200 bar), resulting in de-agglomeration of the graphitic layers and the exfoliation of single-layer and few-layer graphene in high yield.

The combination of high pressure and reduced bond strength between adjacent graphitic layers of the micro-nano platelet graphite increases the amount of single-layer graphene and few-layer graphene that is formed relative to graphene that is exfoliated from graphite using a high sheer exfoliation route. Advantageously, it has been found that by following the method of the present invention the graphene yield could be increased by 20-40% relative to the graphene yields obtained when using conventional high shear treatments to exfoliate graphene from graphite.

Following the combined chemical and high pressure exfoliation treatment the solution obtained is ultra-centrifuged at 10,000-12,000 rpm for 30 minutes using a Fisher scientific Lynx 4000 or Beckmann Coulter (ProteomeLab® XL-A) centrifuge in order to substantially separate the exfoliated graphene from any residual nano-micro platelet graphite.

### EXAMPLE 2: EPOXY COATED SUBSTRATE PREPARATION

A functionalised graphene composition was first prepared by dispersing graphene (1 wt %) in xylene (3.75 wt %) using a dispersing agent (0.25 wt %). In this embodiment the dispersing agent was BYK9076. This solution, which contains “pre-functionalised” graphene, i.e. graphene that has been functionalised with the BYK9076 dispersing agent, was then mixed with a polyamide hardener (23.75 wt %) and this solution was stirred for 5 minutes at 2000 RPM using a paint mixer to ensure that the graphene is homogeneously dispersed throughout the hardener and that graphene is further functionalised with the hardener to obtain functionalised graphene, i.e. graphene that is functionalised with the dispersing agent and with the hardener. 71.25 wt % of bisphenol A diglycidyl ether (DGEBA) resin was then added to the composition comprising functionalised graphene and this mixture was stirred for 5 minutes at 2000 RPM. The functionalised graphene and epoxy resin mixture was then coated onto a mild steel substrate and the steel substrate was thereafter subjected to a heat treatment of 150° C. for 15 mins to cure the resin and to form a hardened coating having a dry film thickness of 45 microns.

### EXAMPLE 3: CORROSION PERFORMANCE

Immersion test: An immersion test was carried out in accordance with ASTM D6943 to assess the corrosion resistance of a DGEBA epoxy coating without graphene and DGEBA epoxy coatings with different loadings (0.1%, 0.5%, 1%, 5%) of functionalised graphene. The coatings were scratched and then the coated substrates were immersed in a 3.5% NaCl solution. The results showed that the DGEBA epoxy coating exhibited severe corrosion and that the extent of corrosion decreases with increasing graphene content. The samples that contained 1% and 5% functionalised graphene exhibited the least corrosion damage.

Electrochemical Analysis:

Electrochemical Impedance Spectroscopy (EIS) and Potentiodynamic Polarization (LP) tests were carried out to obtain a quantitative understanding of how the content of functionalised graphene in DGEBA epoxy coatings influences corrosion resistance and the rate of corrosion.

As shown in FIG. 2, DGEBA epoxy coated samples without functionalised graphene (0%) provide the least coating impedance and hence resistance against corrosion. FIG. 2 also shows that an increasing functionalised graphene content increases the impendence value and hence the coating resistance. In particular, it can be seen that the impedance value reached nine orders of magnitude when 1% of functionalised graphene was incorporated into the DGEBA epoxy coating and that a significant increase in impendence was observed when the functionalised graphene content was increased from 0.5% to 1%.

FIG. 3A shows the results of a set of potentiodynamic polarization experiments that were carried out to evaluate the effect of functionalised graphene content (0.1 wt % (A), 0.5 wt % (B), 1 wt % (C), and 5 (D) wt %) on the rate of corrosion. These experiments were carried out at 250 mV above and below the open circuit potential. From FIG. 3A it can be seen that increasing the content of functionalised graphene in the DGEBA epoxy coating results in a significant reduction in the corrosion rate relative to the observed corrosion rate for DGEBA epoxy coatings without functionalised graphene (E).

Table 1 shows the results of a set of potentiodynamic polarization experiments that compared the rates of corrosion of an epoxy coating comprising 1 wt % of well dispersed functionalised graphene with an epoxy coating comprising non-functionalised graphene. This is also represented graphically in FIG. 3B.

TABLE 1

| | Ecorr | I_{corr} | Corrosion rate |
|---|---|---|---|
| DGEBA coating | (V) | (mA/cm²) | (Mills per year) |
| 1 wt % functionalised graphene | 0.501 | 9 × 10⁻⁶ | 0.0041 |
| 1 wt % non-functionalised graphene | 0.489 | 6.5 × 10⁻⁴ | 0.2964 |

The results showed that significant improvements in corrosion resistance could be obtained when the epoxy coating comprised well dispersed functionalised graphene rather than graphene that was merely added to the epoxy resin, i.e. it was not functionalised with the dispersing agent and the hardener prior to combining with the epoxy resin.

### EXAMPLE 4: ADHESION TEST

A pull off adhesion test was carried out in accordance with ASTM G 4541. Experiments were carried out to investigate the adhesion strength of DGEBA epoxy coatings without graphene and DGEBA epoxy coatings that comprise 1 wt % graphene. As shown in Table 2 below, the pull off strength of the DGEBA epoxy coating is 2.6 MPa, whereas the pull off strength of the DGEBA epoxy coating with 1 wt % functionalised graphene is significantly higher at 4.8 MPa. The increased adhesion has been attributed, at least in part, to both the dispersing agent and the hardener forming a cross-linked network with the epoxy resin, whereas in the conventional DGBEA epoxy coating a cross-linked network is only formed between the hardener and the epoxy resin.

TABLE 2

| | Adhesion strength |
|---|---|
| DGEBA epoxy coating | (MPa) |
| 1 wt % functionalised graphene | 4.8 |
| 0 wt % functionalised graphene | 2.6 |

### EXAMPLE 5: TENSILE AND ELONGATION TESTS

Experiments were also carried out in accordance with ASTM D 882 to evaluate the tensile properties of DGBEA epoxy coatings and DGEBA epoxy coatings comprising 1 wt % functionalized graphene. Test samples were prepared by applying the coatings onto parchment paper using a bar applicator (75 microns wet film thickness). On curing, the coatings were peeled off and test samples were cut to the desired shape and size. The thickness and gauge length of the test samples were measured and thereafter they were mounted within the Universal Testing Machine.

Table 3 below shows the tensile properties of DGBEA epoxy coatings and DGEBA epoxy coatings comprising 1 wt % functionalized graphene. In particular, Table 2 shows that significant improvements in tensile strength can be obtained by incorporating at least 1 wt % of functionalised graphene into the DGEBA epoxy coating. Moreover, it can be seen that the DGEBA epoxy coating comprising functionalised graphene exhibits a two-fold improvement in elongation relative to the DGEBA epoxy coating without graphene.

TABLE 3

| | Tensile Strength | Elongation |
|---|---|---|
| Coating system | (MPa) | (%) |
| 1 wt % functionalised graphene | 1.073 | 28.25 |
| 0 wt % functionalised graphene | 0.4091 | 14.48 |

### EXAMPLE 6: ABRASION STRENGTH TEST

Abrasive strength was measured using a Taber Abrasion method (ASTM D4060). A square steel substrate was first coated with (i) the functionalised graphene based DGEBA epoxy coating and (ii) the DGEBA epoxy coating without functionalised graphene. Then a hole measuring 1 cm in diameter was drilled in the centre of the coated substrate. The weight of the coated substrate was measured and then the coated substrate was fixed to the Taber Abrasion tester with the help of a screw. Based on the hardness of the coating, different abrasive wheels can be used. CS17 wheels are generally used to test epoxy based systems. The coated substrate rotates for 1000 cycles, rubbing against the wheels, after which the weight of the substrate is measured again. The difference in the weight provides an estimate of the coating material loss and hence the abrasive strength of the coating.

As shown in Table 4, the incorporation of functionalised graphene into the DGEBA epoxy coating significantly improves the abrasive strength of the coating relative to the DGEBA epoxy where functionalised graphene is absent from the coating matrix.

TABLE 4

| DGEBA epoxy coating | % weight loss |
|---|---|
| 1 wt % functionalised graphene | 0.37 |
| 0 wt % functionalised graphene | 2.13 |

### EXAMPLE 7: WEATHERING TEST

Experiments were carried out to evaluate the weathering properties of DGBEA epoxy coatings and DGEBA epoxy coatings comprising 1 wt % functionalized graphene. Experiments were conducted in accordance with ASTM G-154 using a QUV weatherometer. The coatings were subjected to a cyclic test with each cycle consisting of 8 h of exposure to “UV light” at 60° C. and thereafter condensation for 4 h at 50° C. A spectrophotometer (BYK) was used to assess any changes in the colour and gloss of the coatings. FIG. 4A shows the variation in colour change (ΔE) vs exposure, whereas FIG. 4B shows the variation in gloss change (ΔG). The results indicate that the epoxy functional group in the epoxy coating (without functionalised graphene) deteriorates on exposure to UV light. Moreover, it can be seen that there is a sudden reduction in ΔE and ΔG within the first 200 hours of exposure to UV light. Although a decrease in ΔE and ΔG is also observed within the first 200 hours for epoxy coatings comprising functionalised graphene, the reduction is less severe. This improvement in colour change and gloss properties has been attributed to the presence of functionalised graphene in the coating matrix that is able to absorb UV radiation.

### EXAMPLE 8: WATER ABSORPTION TEST

The water absorption properties of the functionalised graphene epoxy coating, were compared with an organic zinc rich DGEBA epoxy primer and an inorganic zinc silicate primer. FIG. 8 shows that over time the functionalised graphene epoxy coating absorbs the least amount of water and that it absorbs much less than the zinc rich epoxy primer. Water uptake was calculated by measuring the changes in coating's electrical capacitance over long exposure to aqueous environments using electrochemical impedance spectroscopy (EIS). Capacitive technique is based on the principle that water permeation increases the electrical capacitance of coating.

### EXAMPLE 9: POLYURETHANE COATED SUBSTRATE PREPARATION

A functionalised graphene composition was first prepared by dispersing graphene (5 wt %) in water (4.5 wt %) using a dispersing agent (0.5 wt %). In this embodiment the dispersing agent was DISPERBYK2012. This solution, which contains “pre-functionalised” graphene, i.e. graphene that has been functionalised with the DISPERBYK2012 dispersing agent, was then mixed with a water based DMPA polyol dispersion (60 wt %) and this solution was stirred for 5 minutes at 2000 RPM using a paint mixer to ensure that the graphene is homogeneously dispersed throughout the polyol resin and that graphene cross-links with the polyol resin to obtain functionalised graphene, i.e. graphene that is functionalised with the dispersing agent and with the polyol. 30 wt % of 6-hexamethylene diisocyanate (HDI) hardener was then added to the composition comprising functionalised graphene and this mixture was stirred for 10 minutes at 2000 RPM. The functionalised graphene and HDI hardener mixture was then coated onto a mild steel substrate and the steel substrate was thereafter subjected to a heat treatment of 100° C. for 15 mins to cure the DMPA resin and to form a hardened coating having a dry film thickness of 40 microns.

### EXAMPLE 10: ADHESION TEST

A pull off adhesion test was carried out in accordance with ASTM G 4541. Experiments were carried out to investigate the adhesion strength of polyurethane coatings without functionalised graphene and polyurethane coatings that comprising 5 wt % graphene. As shown in Table 5, the pull off strength of the polyurethane coating without functionalised graphene is 3.8 MPa, whereas the pull off strength of the functionalised graphene polyurethane coating is much higher at 5.4 MPa %.

TABLE 5

| | Adhesion strength |
|---|---|
| DMPA polyurethane coating | (MPa) |
| 5 wt % functionalised graphene | 5.4 |
| 0 wt % functionalised graphene | 3.8 |

### EXAMPLE 11: TENSILE AND ELONGATION TESTS

Experiments were also carried out in accordance with ASTM D 882 to evaluate the tensile properties of DMPA polyurethane coatings comprising 5 wt % functionalized graphene. Test samples were prepared by applying the coatings onto parchment paper using a bar applicator (75 microns wet film thickness). On curing, the coatings were peeled off and test samples were cut to the desired shape and size. The thickness and gauge length of the test samples were measured and thereafter they were mounted within the Universal Testing Machine. Table 6 below shows that significant improvements in tensile strength and elongation were obtained when 5 wt % of functionalised graphene is incorporated into the polyurethane coating.

TABLE 6

| | Tensile Strength | Elongation |
|---|---|---|
| DMPA polyurethane coating | (MPa) | (%) |
| 5 wt % functionalised graphene | 0.5841 | 24.10 |
| 0 wt % functionalised graphene | 0.3142 | 13.47 |

### EXAMPLE 12: ABRASION STRENGTH TEST

Abrasive strength was measured using a Taber Abrasion method (ASTM D4060). A square steel substrate was coated with (i) the functionalised graphene based DMPA polyurethane coating and (ii) the DMPA polyurethane coating without functionalised graphene, and a hole measuring 1 cm in diameter was drilled in the centre of the coated substrate. The weight of the coated substrate was measured and then the coated substrate was fixed to the Taber Abrasion tester with the help of a screw. The coated substrate was rotated for 1000 cycles against a CS17 abrasive wheel after which the weight of the substrate is measured again. As shown in Table 7, the incorporation of 5 wt % functionalised graphene into the DMPA polyurethane coating significantly improves the abrasive strength of the coating relative to the DMPA polyurethane coating where functionalised graphene is absent from the coating matrix.

TABLE 7

| DMPA polyurethane coating | % weight loss |
|---|---|
| 5 wt % functionalised graphene | 0.51 |
| 0 wt % functionalised graphene | 3.21 |

### EXAMPLE 13: WEATHERING TEST

Experiments were carried out to evaluate the weathering properties of polyurethane coatings formed in accordance with Example 9 comprising 5 wt % functionalised grapheme and polyurethane coatings without functionalised graphene. Experiments were conducted in accordance with ASTM G-154 using a QUV weatherometer. The coatings were subjected to a cyclic test with each cycle consisting of 8 h of exposure to “UV light” at 60° C. and thereafter condensation for 4 h at 50° C. A spectrophotometer (BYK) was used to assess any changes in the colour and gloss of the coatings. FIG. 5A shows the variation in colour change (ΔE) vs exposure, whereas FIG. 5B shows the variation in gloss change (ΔG). The results indicate that at any given time the ΔE values observed for the polyurethane coatings comprising functionalised graphene were significantly lower than the ΔE values that were obtained for the corresponding polyurethane coating without functionalised graphene. Similarly, the ΔG values observed for the functionalised graphene polyurethane coating were less than those observed for the polyurethane coating without graphene.

The above embodiments are described by way of example only. Many variations are possible without departing from the scope of the invention.

1. A graphene composition for use in a coating composition that comprises a resin and a hardener, wherein the resin or the hardener is an active hydrogen-containing component and graphene in the graphene composition is functionalised with a dispersing agent and the active hydrogen-containing component.

2. A graphene composition according to claim 1, wherein the dispersing agent comprises any of the following functional groups: —NH₂, —OH and —O═C—NH.

3. A graphene composition according to claim 1, wherein the active hydrogen-containing component is a hardener comprising any of the following functional groups: amino, amide, hydroxyl, carboxylic acid, anhydride, isocyanate, phenol and thiol.

4. A graphene composition according to claim 1, wherein the active hydrogen-containing component is a resin comprising hydroxyl functional groups.

5. A graphene composition according to claim 4, wherein the resin is a polyol.

6. A graphene composition according to claim 1, wherein the graphene is free from oxides.

7. A graphene composition according to claim 1, wherein the graphene composition comprises 1 to 10 μm graphene.

8. A graphene composition according to claim 1, wherein the graphene comprises graphene flakes.

9. (canceled)

10. (canceled)

11. A method of preparing the graphene composition according to claim 1, wherein the method comprises the steps of functionalising graphene with a dispersing agent to form pre-functionalised graphene and then reacting pre-functionalised graphene with an active hydrogen-containing component.

12. A method according to claim 11, wherein the graphene is oxide-free graphene.

13. A method of preparing a composition according to claim 12, wherein the oxide-free graphene is obtained by mining graphite ore from a graphite ore body; subjecting the graphite ore to an electrolytic treatment to obtain an oxide-free expanded graphitic material, and subjecting the expanded graphitic material to an exfoliation treatment to obtain graphene.

14. A method according to claim 13, wherein the electrolytic treatment is carried out in the presence of a non-oxidising electrolyte.

15. A method according to claim 14, wherein the electrolyte comprises ammonium sulphate.

16. A coating composition comprising:
a) a resin;
b) a hardener for hardening the resin;
c) a dispersing agent, and
d) functionalised graphene, wherein the resin or the hardener is an active hydrogen-containing component and graphene is functionalised with the dispersing agent and the active hydrogen-containing component.

17. A coating composition according to claim 16, wherein the coating composition comprises 0.1-5 wt % graphene.

18. A coating according to claim 16, wherein the coating composition comprises 0.1-5 wt % of the dispersing agent.

19. A coating composition according to claim 16, wherein the active hydrogen-containing component is a hardener having any of the following functional groups: amino, amide, hydroxyl, carboxylic acid, anhydride, phenol and thiol and the resin is an epoxy resin.

20. (canceled)

21. A coating composition according to claim 16, wherein the active hydrogen-containing component is a polyol resin and the hardener comprises an isocyanate.

22. A coating composition according to claim 16, wherein the active hydrogen-containing component is a polyol resin and the hardener comprises a carboxylic acid.

23. (canceled)

24. (canceled)

25-28. (canceled)

29. A coating composition according to claim 16, further comprising a substrate with a coating layer formed thereon from the resin, the hardener, the dispersing agent and the functionalized graphene.
